(19) United States
(12) Patent Application Publication
(10) Pub. No.: US 2005/0180558 A1
(43) Pub. Date: Aug. 18, 2005

(54) Method and apparatus for equalizing strong pre-echoes in a multi-path communication channel

(75) Inventor: Yumin Zhang, Plainsboro, NJ (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(73) Assignee: SARNOFF CORPORATION

(21) Appl. No.: 11/062,235

(22) Filed: Feb. 17, 2005

Related U.S. Application Data
(60) Provisional application No. 60/545,053, filed on Feb. 17, 2004.

(51) Int. Cl. H04M 9/08

(52) U.S. Cl. 379/406.1; 379/406.15

(57) ABSTRACT

Disclosed herein is a method and apparatus for providing echo cancellation. A plurality of reflections is received. A first strong reflection of the plurality of reflections is selected as a main path. The first strong reflection is then demodulated.

### CROSS-REFERENCE TO RELATED APPLICATIONS

This application claims benefit of U.S. provisional patent application Ser. No. 60/545,053, filed Feb. 17, 2004, which is herein incorporated by reference.

### BACKGROUND OF THE INVENTION

1. Field of the Invention

The invention relates generally to signal transmission in wireless communication channels. More specifically, the invention relates to echo cancellation in wireless communication channels.

2. Description of the Related Art

In wireless communication channels, the transmitted signal may travel through different paths, being delayed and attenuated by different objects (buildings, trees, mountains), before arriving at the receiver antenna. This channel is called a multi-path channel and the reflections are called “ghosts” or “echoes”. Normally, one of the echoes is the strongest and is treated as the “main path”. Echoes arriving earlier than the main path are called “pre-echoes”, and echoes arriving later than the main path are called “post-echoes”. FIG. 1 shows a multipath profile for a channel. The echoes produce the inter-symbol interference (ISI), which must be dealt with using DSP methods before the slicer in the receiver can make correct decisions for further processing.

Adaptive equalizers are used in communication receivers to cancel echoes. A typical Decision Feedback Equalizer (DFE) has a feed-forward (FF) filter and a decision feedback (DF) filter. Pre-echoes are canceled by the FF filter, and post-echoes are cancelled by the DF filter. Post-echoes are easier to cancel, because each post-echo only requires one tap in the DF filter to cancel.

FIG. 2 shows the channel profile and the corresponding equalizer taps for a channel with a single post-echo. It should be noted that one non-zero tap in the DF filter is needed to cancel the post-echo. Pre-echoes are much more difficult to cancel, since one pre-echo will require many taps in the FF filter to cancel. If there is a strong pre-echo far ahead of the main path, many FF taps are needed just to cancel that one echo.

FIG. 3 shows the channel profile and the corresponding equalizer taps for a channel with a strong pre-echo. It should be noted that many non-zero taps in the FF filter are needed, and the span of the FF filter taps is much longer than the range of the pre-echo. The number of FF taps required can be too large to implement in a practical system. Consider the following example: In an 8-VSB DTV system, the symbol rate is 10.76M symbols/second. If a single pre-echo of −3 dB power (main path has normalized power of 0 dB) is located 10 microseconds ahead of the main path, the FF filter would need more than 750 taps to cancel that pre-echo. This translates into an impractical amount of hardware for a consumer product.

Prior art equalizer methods were designed to receive/demodulate the strongest main path signal, and cancel all other echoes. Some methods perform some “pre-processing” before equalization. The pre-processing may try to convert pre-echoes into easier-to-deal “post-echoes” through filtering. The equalizer then tries to demodulate the strongest main path and cancel all other post-echoes. The problem with the pre-processing approach is: “pre-processing” requires extra hardware and computation power. Thus, the “pre-processing” reduces pre-echoes, but generates more post-echoes far behind the main path. Therefore requiring the DF filter to be lengthened to cover the longer post-echo range.

Therefore, there is a need in the art for a method and apparatus that handles strong pre-echoes without requiring pre-processing.

### SUMMARY OF THE DISCLOSURE

Disclosed herein is a method and apparatus for providing echo cancellation. In one embodiment, a plurality of reflections is received. A first strong reflection of the plurality of reflections is selected as a main path. The first strong reflection is then demodulated.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a multipath profile for a channel;

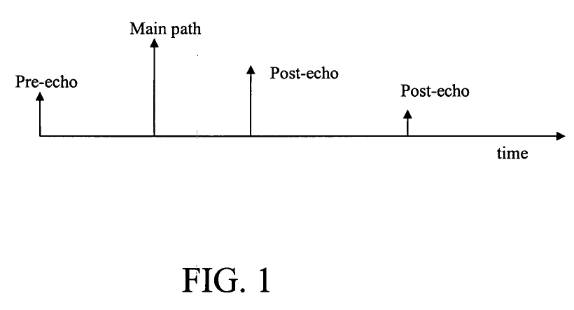

FIG. 2 illustrates the channel profile and the corresponding equalizer taps for a channel with a single post-echo;

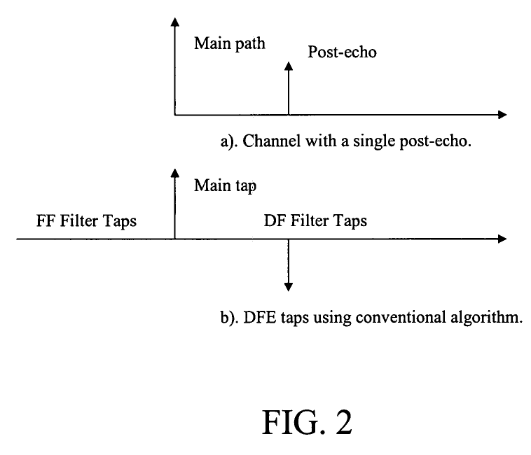

FIG. 3 illustrates the channel profile and the corresponding equalizer taps for a channel with a strong pre-echo;

FIG. 4 illustrates a receiver in accordance with one embodiment of the present invention;

FIG. 5 illustrates an adaptive equalizer in accordance with one embodiment of the present invention;

FIG. 6 illustrates a diagram of a method in accordance with one embodiment of the present invention;

FIG. 7 illustrates a multi-path channel and the a comparison of conventional methods with one method of the present invention; and

FIG. 8 illustrates a block diagram of a signal processing device or system in accordance with one embodiment of the present invention.

### DETAILED DESCRIPTION

Disclosed is a method to handle strong pre-echoes. It should be noted that the “pre-echo”, “main path”, and “post-echo” of a signal are all reflections. The “main path” in prior art systems was chosen arbitrarily simply because it is the strongest. All previous methods demodulate the strongest reflection, and cancel all other reflections. The method of the invention searches for the first strong (not necessarily the strongest) reflection and treats it as the “main-path.” All other reflections after the first strong reflection are treated as “post-echoes” and are cancelled by the DF filter. The remaining small reflections before the new “main path” are easier to cancel, because their amplitudes (or power) are very small and only need a small number of FF filter taps.

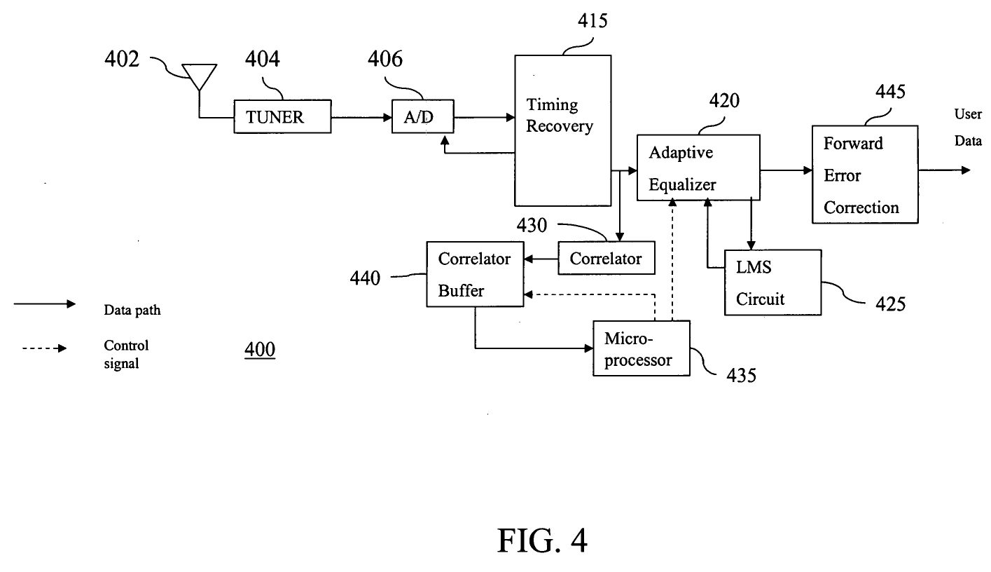

FIG. 4 illustrates a receiver 400 in accordance with one embodiment of the present invention. In one embodiment, receiver 400 is capable of receiving radio frequency (RF) signals in any desired frequency band (e.g., a 5 GHz wireless band). The RF signals can be modulated using any modulation scheme, such as, but not limited to, M-ary quadrature amplitude modulation (QAM), or quadrature phase-shift keying (QPSK).

Antenna 402 receives replicas of a transmitted RF signal. Antenna 402 is coupled to tuner 404. Tuner 404 filters and downconverts the received signal to near baseband. The near baseband signals are respectively coupled to the analog-to-digital (A/D) converter 406. The digitized signal is applied to timing recovery circuit 415. Timing recovery circuit 415 generates a signal at the symbol rate fs, synchronizes this signal to the best estimate of the transmitted data, and then identifies symbol timing information for decoding and synchronization purposes.

The samples are then coupled to an equalizer 420. The samples are also coupled to correlator 430. Correlator 430 (matched filter matched with the PN sequence) in the receiver detects the arriving of each echo, e.g., reflection. Each echo is temporarily stored in correlator buffer 440. Microprocessor 435 determines a magnitude of each echo stored in correlator buffer 440. The magnitude of the correlator output indicates the strength of the echo. Based on the strength of each echo, microprocessor 435 directs equalizer 420 to demodulate the first strong (not necessarily the strongest) echo, other echoes after the first strong echo are cancelled by a DF filter. An error signal from equalizer 420 is coupled to a Least Mean Squares (LMS) circuit 425, which performs an LMS algorithm to adjust the tap weights of equalizer 420. The equalized symbols are then available for further processing by forward error correction circuit 445.

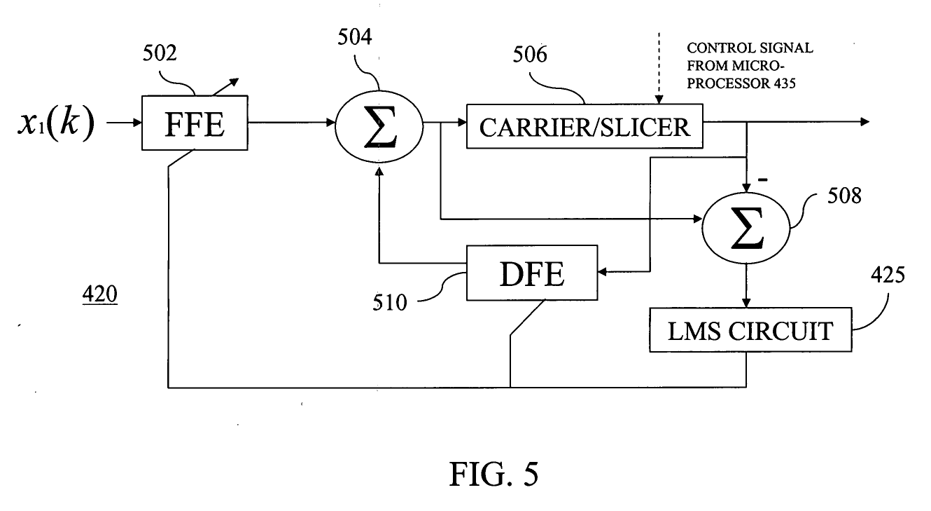

FIG. 5 illustrates an adaptive equalizer in accordance with one embodiment of the present invention. In one embodiment, equalizer 450 comprises feed forward equalizer (FFE) 502, a combiner 504, a carrier loop recovery circuit and slicer combined circuit 506, a subtractor 508, a decision feedback equalizer (DFE) 510, and a least mean square (LMS) circuit 425. FFE 502 is a multi-tap equalizer that delays its respective signal to achieve equal delay in the received signal on a symbol spaced basis. Once temporally equalized by FFE 502, the signal is combined in combiner 504. The output of combiner 504 is coupled to a single circuit 506 comprising both a carrier loop recovery circuit and a slicer. Least mean squares (LMS) circuit 425 uses the error signal to produce tap weight adjustments for all the equalizers: FFE 502 and DFE 510.

The carrier/slicer circuit 506 comprises a carrier loop recovery circuit that extracts the carrier from the equalized symbols and a slicer circuit that samples the symbols to generate estimated symbols. The carrier loop recovery circuit is used to correct for any frequency or phase offset in the received signal, thus mitigating some of the Doppler effects. The output of the carrier/slicer circuit 506 is coupled to the DFE 510 for temporal equalization and the removal of intersymbol interference. The output of the DFE 510 is coupled to the combiner 504. The slicer in the carrier/slicer circuit 506 and subtractor 508 are used to produce a symbol error that is coupled to LMS circuit 425, that is, the slicer together with the subtractor 208 compares the estimated symbol sample with the known symbol and generates an error signal. As described above, the LMS circuit 425 uses the error signal to produce tap weight adjustments for all the equalizers: FFE 502 and DFE 510.

Correlator 430 detects the beginning of a reflection. In one embodiment, correlator 430 detects a delayed version of a training sequence. Once microprocessor 435 receives data from correlator buffer 440, microprocessor 435 is alerted to the beginning of the PN sequence. Microprocessor 435 alerts carrier/slicer 506 to the beginning of the PN sequence and the carrier/slicer 506 locally generates a copy of the PN sequence. The locally generated PN sequence and the equalizer output are then used to calculate the error signal.

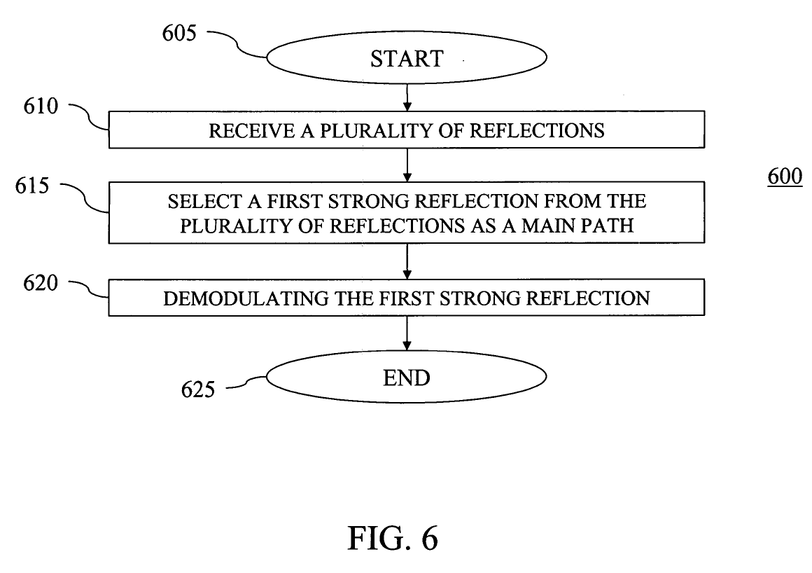

FIG. 6 illustrates a diagram of a method 600 in accordance with one embodiment of the present invention. Method 600 begins at step 605 and proceeds to step 610. In step 610, a plurality of signals is received. The plurality of reflections may comprise a transmitted signal and at least one reflection, e.g., echo, of the transmitted signal.

In step 615, a first strong reflection is selected from the plurality of reflections as a main path. In one embodiment, the present invention may be implemented in Digital TV receivers in an 8-VSB system. In an 8-VSB Digital TV signal, there are known signals embedded in the transmitted signal. These known signals may be pseudo-random sequences and may be used as a training sequence for the equalizer. Pseudo-Random sequences (PN sequences) have very good correlation properties. Two different PN sequences have very small correlation. Also, a PN sequence has very small correlation with a delayed version of itself. Thus, a correlator, i.e., correlator 430 generates a significant output only when two PN sequences are perfectly aligned. The magnitude of the correlator output indicates the strength of the echo. Thus, a correlator (e.g., a matched filter matched with the PN sequence) in the receiver can easily detect the arriving of each echo. The first strong reflection, e.g., first strong echo, is selected in accordance with a threshold. The first strong reflection may be selected by the microprocessor using at least the following three parameters: the number of available FFE filter taps, the magnitude of the reflection, and the distance between a particular reflection and the strongest reflection. In one illustrative example, the threshold may be determined according to the following formula:

$$ceil ( \frac{20}{AttdB} ) T + 1 \leq NbFFE$$

where ceil( ) rounds to the next bigger integer, AttdB is the echo attenuation in dB (no minus sign), T is the distance in symbols between the pre-echo and the strongest path (0 dB path), and NbFFE means the number of FFE taps. The above equation states the relation that must be satisfied for a single pre-echo to be cancelled. Given any two the three parameters, the other can be derived. For example, if we have 64 FFE taps and the correlator indicates that a pre-echo is 10 symbols ahead of the 0 dB path (T=10), the max echo strength the FFE can cancel is −3.4 dB based on the above equation. If the correlator indicates that the pre-echo is stronger than −3.4 dB, then it must be treated as a main path. Conventional algorithm will not be able to cancel this pre-echo using 64 FFE taps.

In one embodiment, the correlator method described above may also be used for timing recovery. Since the PN sequences (and the Segment Sync sequence) in VSB signal come regularly, the regular occurrence of a big output at the correlator can be used for recovering the symbol clock.

In step 620, the first strong reflection is demodulated. Once the echoes are detected by the correlator, i.e., correlator 430, the equalizer, i.e., equalizer 425 uses that information to demodulate the first strong (not necessarily the strongest) echo. Echoes occurring after the first strong echo are designated as post-echoes and cancelled by DF filter, i.e., DFE 510. Echoes occurring before the first strong echo, are designated as pre-echoes and cancelled by the FF filter, i.e., FFE 502. The FF filter requires less taps since the first strong reflection is demodulated instead of the strongest reflection.

Most adaptive equalizers need an error signal to calculate and update the equalizer tap coefficients. For each incoming symbol, the equalizer calculates an error signal e=y−I, where y is the equalizer output and I is the transmitted symbol. In normal data reception mode, the transmitted signal I is unknown. A common solution is to use the slicer output as an estimate of the transmitted symbol I or to use some “blind” method which produces an error signal without knowing exactly what is transmitted.

In one embodiment, during the training period, a copy of the known training sequence may be generated locally in the receiver and used in the calculation of error signal e. Note that for a multipath channel, the training sequence has several delayed versions arriving at the receiver. As discussed previously, the correlator, e.g., correlator 430 in the receiver 400 can detect the start of each echo (delayed version of the training sequence). By aligning the locally generated training sequence with one of the arriving echoes, the equalizer will lock on to that particular echo and all other echoes will be cancelled.

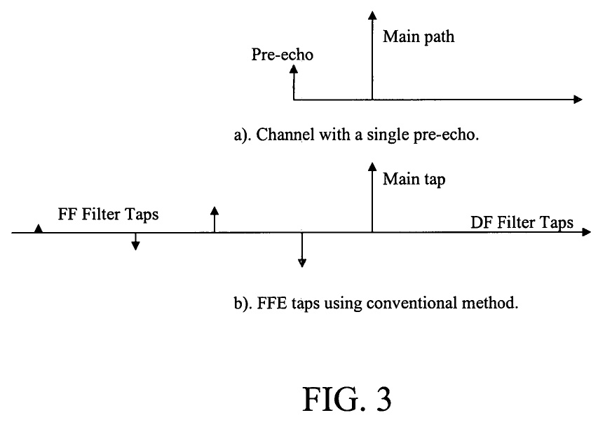

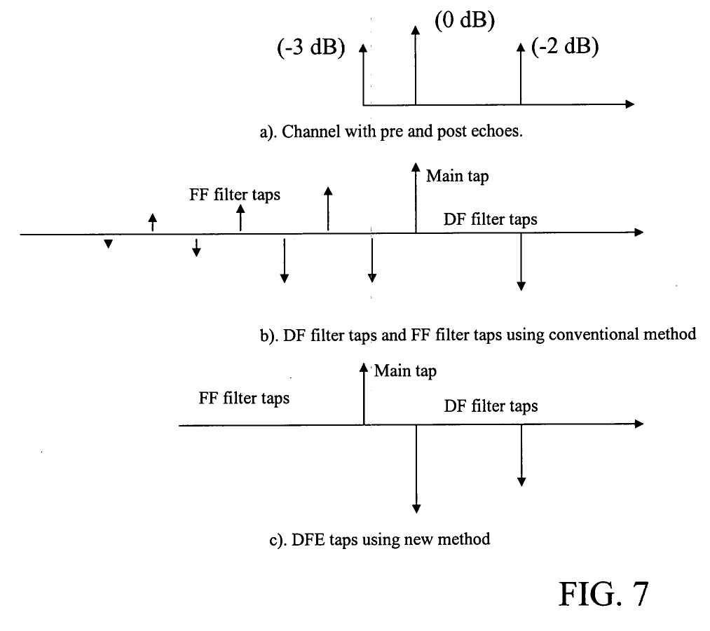

FIG. 7 illustrates a multi-path channel and the different processing between the conventional methods and the method of the invention. The method of the invention is best illustrated by the following example. Consider the 8-VSB example discussed above with respect to FIG. 3. FIG. 3 shows a channel with one pre-echo. Similarly, FIG. 7a) shows a channel with one pre-echo and one post-echo. FIG. 7b) illustrates how taps are determined using the conventional method. In the conventional method, a strong pre-echo requires a large amount of feed forward (FF) taps. If the pre-echo has a magnitude of −3 dB and is 107 symbols before the 0 dB echo, 750 FF taps would be necessary in order to cancel the pre-echo. In FIG. 7c), instead of trying to cancel the pre-echo, the equalizer treats the pre-echo as the “main path” to demodulate. The original “main-path” (O-dB) is now treated as a post-echo. The −2-dB echo is also treated as a post-echo. Only two taps are needed in the DF filter to cancel the O-dB echo, which is 107 taps away, and the −2-dB echo. In other words, only 107 taps are needed in the DF filter to cover the 10 micro-second echo range (between the −3-dB and O-dB reflections), instead of the 750 FF filter taps required using the “conventional” equalizer method. Of course 3 dB is lost in the received signal strength, however, this solution is still attractive due to the huge reduction in the number of equalizer taps required. The above example is for one-single pre-echo. If there are multiple strong pre-echoes, the “earliest” strong pre-echo can be demodulated while all other pre-echoes (after the first strong one), (i.e. main path, and post-echoes) are cancelled by the DF filter as if they are all “post-echoes”.

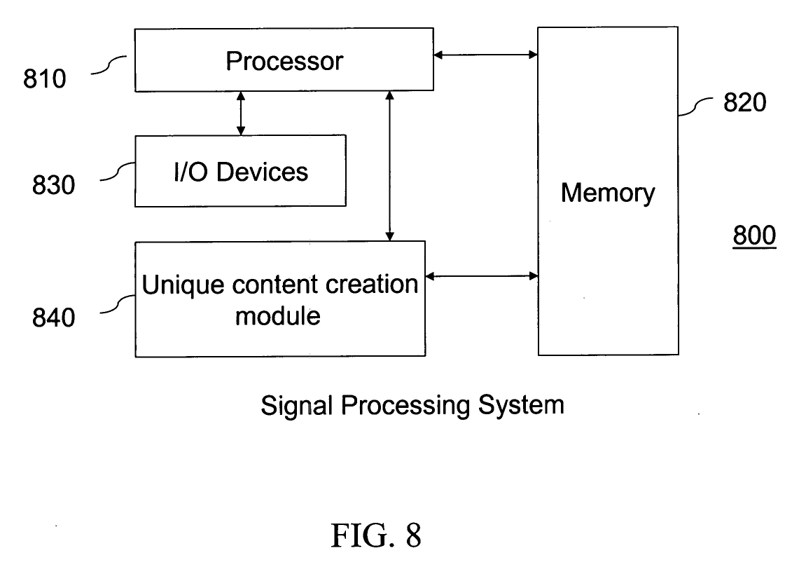

FIG. 8 illustrates a block diagram of a signal processing device or system 800 of the present invention. Specifically, the system can be employed to provide echo cancellation. In one embodiment, the signal processing device or system 800 is implemented using a general purpose computer or any other hardware equivalents.

Thus, signal processing device or system 800 comprises a processor (CPU) 810, a memory 820, e.g., random access memory (RAM) and/or read only memory (ROM), echo cancellation module 840, and various input/output devices 830, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the echo cancellation module 840 can be implemented as one or more physical devices that are coupled to the CPU 810 through a communication channel. Alternatively, the echo cancellation module 840 can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 820 of the computer. As such, the echo cancellation module 840 (including associated data structures) of the present invention can be stored on a computer readable medium, e.g., RAM memory, magnetic or optical drive or diskette and the like.

While the foregoing is directed to illustrative embodiments of the present invention, other and further embodiments of the invention may be devised without departing from the basic scope thereof.

1. A method for providing echo cancellation, comprising:
receiving a plurality of reflections;
selecting a first strong reflection of said plurality of reflections as a main path; and
demodulating said first strong reflection.

2. The method of claim 1, wherein said plurality of reflections comprises a transmitted signal and at least one reflection of said transmitted signal.

3. The method of claim 1, wherein known signals are embedded in each of the plurality of reflections.

4. The method of claim 3, wherein known signals are locally generated.

5. The method of claim 4, wherein the embedded known signals and the locally generated known signals comprise pseudorandom sequences.

6. The method of claim 4, wherein an output corresponding to each reflection is generated when the embedded known signals and the locally generated known signals are aligned.

7. The method of claim 1, wherein said first strong signal is selected in accordance with a threshold.

8. An apparatus for providing echo cancellation, comprising:
means for receiving a plurality of reflections;
means for selecting a first strong reflection of said plurality of reflections as a main path; and
means for demodulating said first strong reflection.

9. The apparatus of claim 8, wherein said plurality of reflections comprises a transmitted signal and at least one reflection of said transmitted signal.

10. The apparatus of claim 8, wherein known signals are embedded in each of the plurality of reflections.

11. The apparatus of claim 10, wherein known signals are locally generated.

12. The apparatus of claim 11, wherein the embedded known signals and the locally generated known signals comprise pseudorandom sequences.

13. The apparatus of claim 11, wherein an output corresponding to each reflection is generated when the embedded known signals and the locally generated known signals are aligned.

14. The apparatus of claim 8, wherein said first strong signal is selected in accordance with a threshold.

15. A computer-readable medium having stored thereon a plurality of instructions, the plurality of instructions including instructions which, when executed by a processor, cause the processor to perform the steps of a method for providing echo cancellation, comprising:
receiving a plurality of reflections;
selecting a first strong reflection of said plurality of reflections as a main path; and
demodulating said first strong reflection.

16. The computer-readable medium of claim 15, wherein said plurality of reflections comprises a transmitted signal and at least one reflection of said transmitted signal.

17. The computer-readable medium of claim 15, wherein known signals are embedded in each of the plurality of reflections.

18. The computer-readable medium of claim 17, wherein known signals are locally generated.

19. The computer-readable medium of claim 18, wherein an output corresponding to each reflection is generated when the embedded known signals and the locally generated known signals are aligned.

20. The computer-readable medium of claim 15, wherein said first strong signal is selected in accordance with a threshold.
